(19) United States
(12) Patent Application Publication
(10) Pub. No.: US 2025/0122628 A1
(43) Pub. Date: Apr. 17, 2025

(54) ELECTROMECHANICAL HYDROGEN GENERATOR

(71) Applicant: H2GENERATION INC., Cornwall (CA)

(72) Inventor: Colin Kerr, Halifax (CA)

(73) Assignee: H2GENERATION INC., Cornwall, ON (CA)

(21) Appl. No.: 18/684,602

(22) PCT Filed: Aug. 18, 2022
(86) PCT No.: PCT/IB2022/000475

§ 371 Date: Feb. 16, 2024

Related U.S. Application Data
(60) Provisional application No. 63/234,647, filed on Aug. 18, 2021.

(51) Int. Cl. C25B 1/04; C25B 9/65; C25B 9/70; C25B 15/027

(52) U.S. Cl. CPC C25B 1/04; C25B 9/65; C25B 9/70; C25B 15/027

(57) ABSTRACT

Embodiments are disclosed comprising an electromechanical device that generates hydrogen from mechanical energy without requiring an external source of electrical energy. In one embodiment, for example, the only external energy required is rotational energy and the necessary electrical energy for electrolytic dissociation of water is generated internally to the device. Various aspects of embodiments of the invention provide enhanced efficiency for generating hydrogen. Details of various embodiments are further described herein.

### CROSS-REFERENCE TO RELATED APPLICATIONS

This application claims the benefit of U.S. Provisional Application Ser. No. 63/234,647 filed on Aug. 18, 2021. The entire contents of that application are hereby incorporated by reference herein.

### SUMMARY

Hydrogen has become increasingly important as a source of clean fuel and energy storage. It is readily generated from water via electrolysis with the only byproduct being oxygen. However, existing hydrogen generators typically rely on external sources of electrical energy.

Embodiments of the present invention comprise an electromechanical device that generates hydrogen from mechanical energy without requiring an external source of electrical energy. In one embodiment, for example, the only external energy required is rotational energy and the necessary electrical energy for electrolytic dissociation of water is generated internally to the device. Various aspects of embodiments of the invention provide enhanced efficiency for generating hydrogen. Details of various embodiments are further described herein.

### BRIEF DESCRIPTION OF THE DRAWINGS

FIG. 1 illustrates an exterior perspective view of an electromechanical device in accordance with an embodiment of the invention.

FIG. 2 is a front elevation view of a portion of the interior of the embodiment of FIG. 1.

FIG. 3 is a top, plan view of a portion of the interior of the embodiment of FIG. 1.

FIG. 4 illustrates front profiles of the segments of outer and inner rotating magnetic rings referenced in FIG. 2 and FIG. 3.

FIGS. 5A-5B show details of the electrolytic cell referenced in FIGS. 2 and 3.

FIG. 6 illustrates further details of the cylindrical separator that separates the cathode and anode shown in FIGS. 5A-5B.

FIG. 7 shows details of the magnetic cell referenced in FIGS. 2 and 3.

While the invention is described with reference to the above drawings, the drawings are intended to be illustrative, and other embodiments are consistent with the spirit, and within the scope, of the invention.

### DETAILED DESCRIPTION

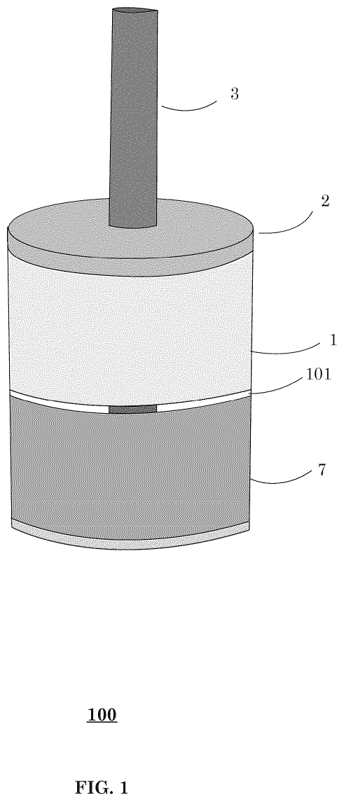

FIG. 1 is an exterior perspective view of a hydrogen generator 100 in accordance with an embodiment of the present invention. Upper outer cylinder 1 (covered by cover 2), as further explained in the context of other figures, includes within it outer and inner concentric rings of magnets mounted to rotate around stationary electrolytic and magnetic cells in response to torque applied to drive shaft 3 by an external mechanical force. Lower, stationary cylinder 7 provides support structure for the stationary electrolytic and magnetic cells and for other elements including bearings supporting drive shaft 3, electrolyte distribution structures, hydrogen collection structures and other elements. Slot 101 provides an opening through which oxygen, the electrolytic reaction's byproduct, is vented to the surrounding atmosphere.

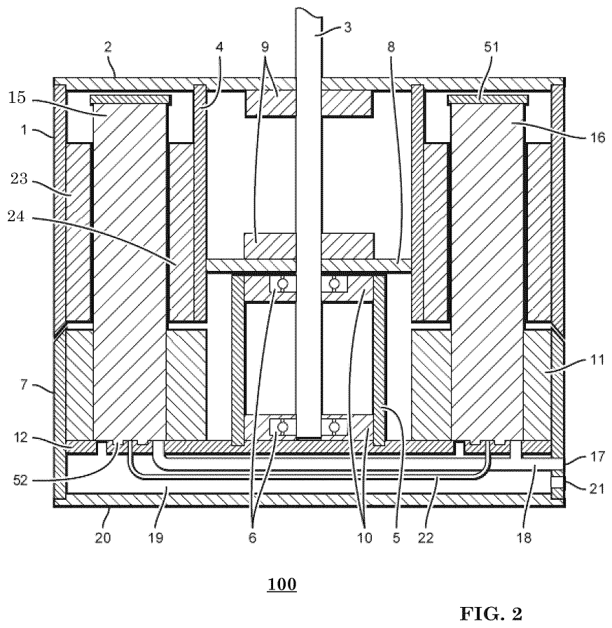

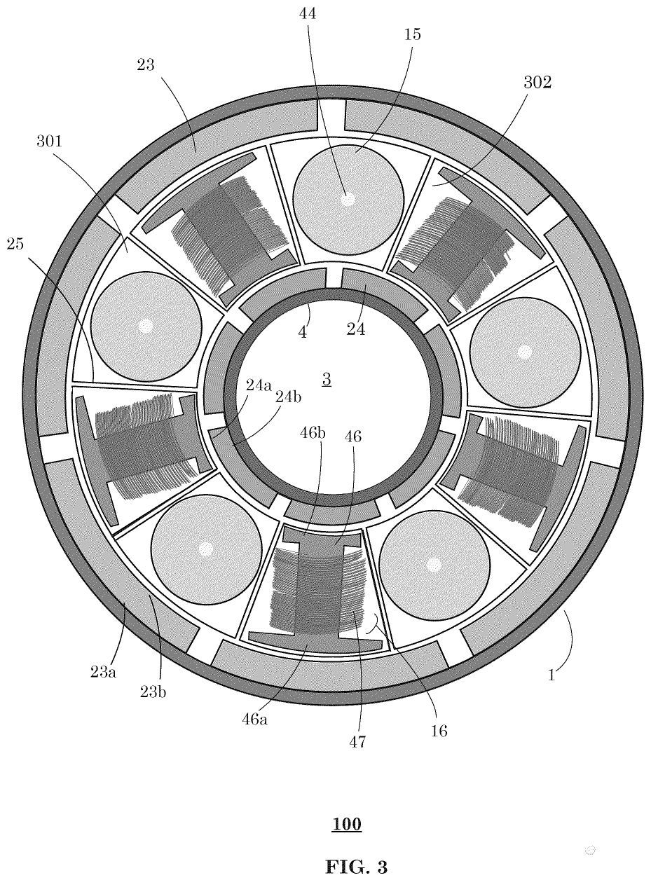

FIG. 2 is a front elevation view of a portion of the interior of the embodiment of FIG. 1. FIG. 3 is a top view of a portion of the interior of the embodiment of FIG. 1.

With reference to FIG. 2, rotating upper cylinder 1 is closed at the top by a flat cover 2, with a central drive shaft 3 fixed to and projecting upwards at the center of the cover, and continuing down through the center of the upper inner cylinder 4 and through the stationary lower inner cylinder 5, where it rotates in the bearings 6. The shaft 3 therefore ensures that the motion of the rotating cylinder 1 is coaxial with the stationary cylinder 7 and all the components mounted on it. The stiffness of the rotational mounting arrangement is sufficient to allow for a minimal magnetic gap between the rotating magnets and the magnetic cells.

The interior structure of the rotating cylinder 1 consists of an inner cylinder 4 and a stabilizing disc 8, held together by the collars 9, which are securely bonded to their adjacent surfaces.

The interior structure of the stationary outer cylinder 7 includes the bearing retainers 10 and bearings 6 inside the inner lower cylinder 5, as well as an annular cell retainer block 11 attached to the cell mounting plate 12.

Magnet (permanent magnet or electromagnet) ring segments 23 and 24 (outer and inner respectively) with radiused faces are arranged around and bonded to the inside of cylinder 1 and the outside of cylinder 4, as further shown in FIG. 3.

FIG. 2 shows one electrolytic cell 15 and one magnetic cell 16 on opposite sides of the cylindrical arrangement. In a primary embodiment, an outer magnet ring comprises a plurality of magnet segments 23, arranged as illustrated in FIG. 3 around an inner wall of cylinder 1. An inner magnetic ring comprises a plurality of magnet segments 24 arranged around the outer wall of cylinder 4 as shown in FIG. 3. In this embodiment, outer ring magnet segments 23 alternate in polarity relative to adjacent segments 23. Adjacent inner ring magnet segments 24 are similarly arranged to alternate in polarity. However, in an alternative embodiment, polarities are oriented in the same direction (homopolar). And in another alternative embodiment, a magnet ring comprises a single continuous magnet rather than a plurality of magnet segments.

With reference to FIG. 2, electrolytic cells 15 and magnetic cells 16 are securely inserted into the annular composite cell retainer 11 mounted on the stationary cell mounting plate 12. Preferably, the electrolytic cells 15 and magnetic cells 16 are dimensioned and arranged such that the space between those cells and the magnet ring segments 23 and 24 is as small as practically possible while still allowing the magnet ring segments to rotate freely relative to electrolytic and magnetic cells 15 and 16. In other words, there should be a minimal magnetic gap that is preferably only as big as necessary to allow rotational passage of the magnets past the cells without touching them.

Water is supplied to the electrolytic cells through the water inlet 17 and the water distribution tubes 18. The electrolytic cells and magnetic cells are locked into position on the cell mounting plate 12 by identical molded cylindrical locating dimples 52 on the underside of their bases which mate with holes punched into the mounting plate.

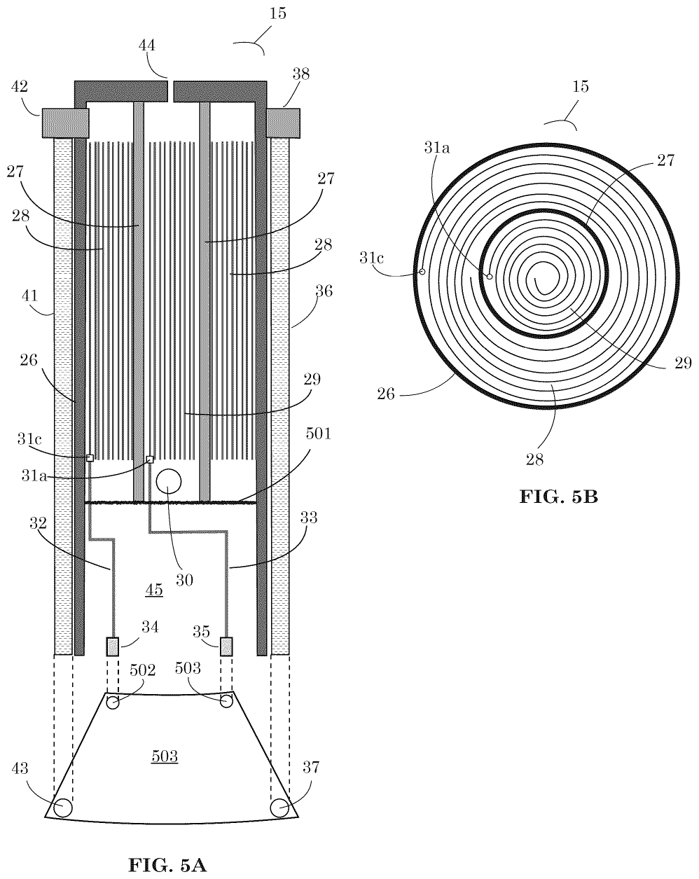

Rotating the shaft 3 causes the pairs of inner and outer magnets (24 and 23 respectively) to move past the magnetic cells, generating current to electrolyze the water in the corresponding electrolytic cells 15. The current generated in a winding of a magnetic cell 16 is conveyed to a connected electrolytic cell 15 via internal connections 22. As the water is electrolyzed, bubbles of hydrogen and oxygen are produced which rise to the tops of the cells 15. The oxygen is vented through holes 44 in the tops of the electrolytic cells (see FIG. 3 and FIG. 5A) and into the atmosphere through the space between the rotating cylinder 1 and the stationary base assembly. The hydrogen is expelled by natural pressure through the bases of the electrolytic cells and is collected in the hydrogen plenum 19, located in the space between the cell mounting plate and the baseplate 20, for extraction through the hydrogen outlet 21.

FIG. 3 shows that, in the primary embodiment, a plurality of compartments 301 and 302 are defined by outer composite casings 25. Within each compartment 301 is an electrolytic cell 15. Within each compartment 302, is a magnetic cell 16. The illustrated embodiment shows electrolytic cells 15 and magnetic cells 16 arranged in alternating fashion. However, in alternative embodiments, this need not be the case. Moreover, in alternative embodiments, there can be fewer magnetic cells (e.g., as few as one magnetic cell) and fewer electrolytic cells (e.g., as few as one electrolytic cell).

As shown in FIG. 3, each magnetic cell 16 comprises a magnetic (i.e., magnetizable) core 46 with outer pole portion 46a and inner pole portion 46b as well as a winding 47. Core 46 and its corresponding pole portions are made of magnetic steel or other magnetizable metal. One skilled in the art will appreciate that magnetic steel or other magnetizable metals become magnetic in the presence of a magnetic field, but lose magnetism when the magnetic field is removed. Magnetic fields are created in compartments 302 as an outer magnetic segment 23 and a corresponding inner magnetic segment 24 come into proximity to a magnetic cell 16 as outer cylinder 1 is rotated by the turning of drive shaft 3. These magnetic fields induce magnetic fields in a corresponding magnetic core 46 having pole portions 46a and 46b.

In the illustrated embodiment, polarities of outer ring magnet segments 23 are alternating from segment to segment around the cylindrical structure. Outer edge 23a of a given segment 23 has a first polarity and inner edge 23b has a second, opposite polarity. Similarly, polarities of inner ring magnet segments 24 are alternating from segment to segment around the cylindrical structure. Outer edge 24a of a given inner segment 24 has a first polarity and inner edge 24b of that segment has a second, opposite polarity.

Moreover, in the illustrated embodiment, pairs of segments including one outer ring segment 23 and one inner ring segment 24 traverse a given magnetic cell 16 at time and their polarities are arranged such that the polarity of inner edge 23b of an outer ring segment 23 is opposite the polarity of an outer edge 24a of a corresponding inner ring segment 24. This helps maximize the magnetic field across the given magnetic cell 16.

Furthermore, if the polarities of segments 23 (and segments 24) are alternating from one to the next around the cylindrical structure, then it is also preferrable that spacing between adjacent magnet segments 23 (and adjacent magnetic segments 24) is greater than the curved lengths of inner and outer pole portions 46b and 46a of a given core. That way, no more than one pair of inner and out magnet segments 23 and 24 are traversing a given magnetic cell at a time.

Finally, in an embodiment, electrolytic cells 15, magnetic cells 16, and corresponding compartments 301 and 302 in which they are housed are sized such that a top-view profile of an electrolytic cell 15 (and that of a magnetic cell 16) fills up more of the total space than is shown in the illustration of FIG. 3. As noted, the components in the drawings are not necessarily drawn to scale relative to each other to make it easier to illustrate the underlying principles of the depicted embodiments. However, were FIG. 3 drawn closer to scale, less empty space between each cell (i.e., each electrolytic cell 15 and each magnetic cell 16) and a corresponding outer composite casing 25 of a compartment 301 or 302 would be shown.

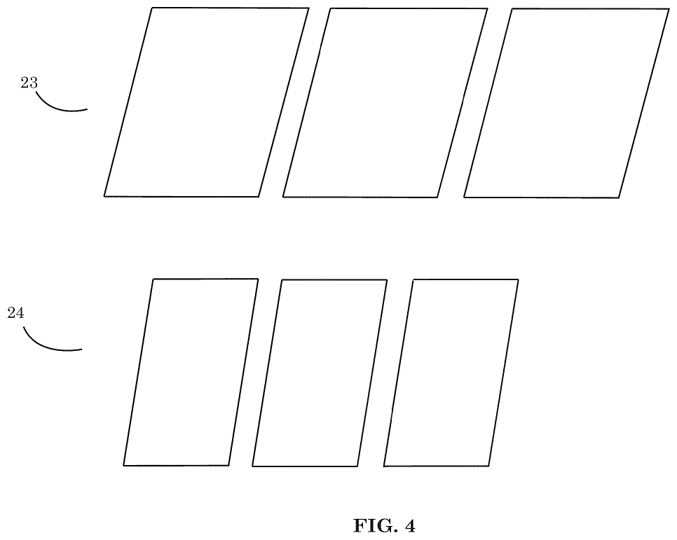

FIG. 4 illustrates the broad-side surface profiles (in two-dimensional flat view) of outer ring magnet segments 23 and inner ring magnet segments 24 (e.g., an inward facing concave surface of outer ring segment 23, an outward facing concave surface of an inner ring segment 24, etc.). In a permanent magnet embodiment, neodymium or other permanent magnet material is molded prior to magnetization into concave shapes so that the outer ring magnet segments 23 match the curvature of the inside surface of the upper outer cylinder 1, and the inner ring magnet segments 24 match the outside curvature of the surface of the upper inner cylinder 4. In an electromagnet embodiment, magnet segments are similarly shaped.

The parallelogram shapes of the profiles of the magnet segments are designed to minimize magnetic cogging as the vertical edges of the magnet segments traverse the edges of the magnetic cores 46 embedded in the magnetic cells 16.

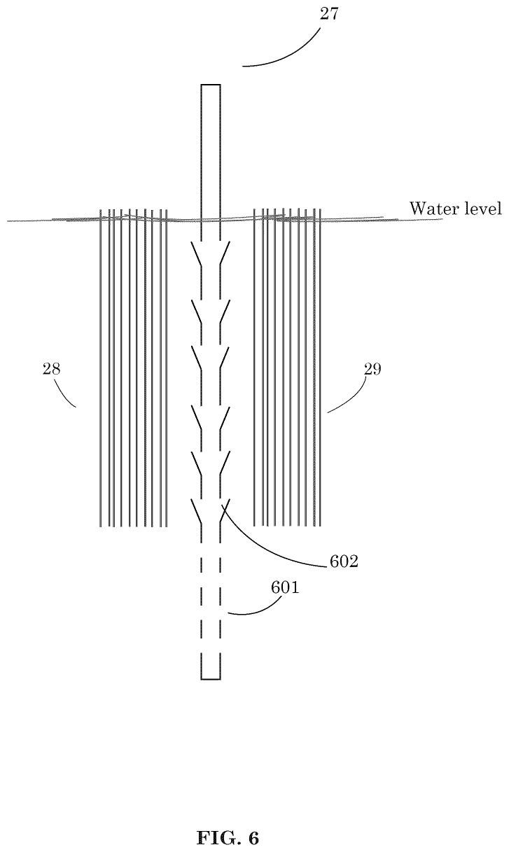

FIGS. 5A-5B (5B being a top view) illustrates an electrolytic cell 15 along with certain associated components. Cell 15 includes its surrounding cylindrical cell casing 26. Casing 26 surrounds spiral cathode 28 which in turn surrounds spiral anode 29. Cylindrical composite separator 27 separates anode 28 from anode 29 while still allowing electric currents in the electrolytic fluid to pass between the two. As further illustrated in FIG. 6, separator 27, in a particular embodiment, also has flap openings arranged to allow such flow in the fluid while still deflecting any gas bubbles (hydrogen bubbles from the cathode side and an oxygen bubbles from the anode side) such that gas is not exchanged through separator 27.

In the particular embodiment, cathode 28 and anode 29 can each be structurally understood rolled thin sheet of conductive metal, an arrangement which maximizes the surface area contact between the cathode and anode material and the electrolytic fluid.

In the particular embodiment illustrated, water enters from distribution channel 18 (see FIG. 2) through opening 37 in bottom cover 503 (cover reference 503 underlined in the drawing, the other 503—not underlined—is a hole in cover 503 for allowing access to connector 35) and proceeds, under pressure, up through tube 36, valve assembly 38, and then down through another tube (other tube not separately shown) behind the illustrated portion of cell 15 and enters the area just below anode 29 and cathode 28 via hole 30 through cylindrical cell casing 26. Water fills the anode and cathode regions (above floor 501 formed by composite filler 45) and rises until valve assembly 38 (in conjunction with the back tube not separately shown and a conical float) closes off a supply from receiving more water via tube 36 until the level drops below a designate level near the top of cathode 28 and anode 29. This is just one embodiment for introducing water to the electrolytic cell and controlling its level. Many alternatives would be known to one skilled in the art.

Hydrogen evolving from cathode 28 occupies the space over cathode 28 and, under natural pressure, moves through fitting 42 and down through tube 41, exiting to plenum 19 where it can be collected from the cell via outlet 21 as illustrated and discussed in the context of FIG. 2. In alternative embodiments, a hydrogen plenum through which hydrogen is collected via an outlet could reside at the top of the cell rather than at the bottom. Other alternatives are also possible and are well within the reach of one of ordinary skill in the relevant art.

Oxygen evolving from anode 29 vents through openings 44 and 101 as previously discussed.

The electrolytic cell is powered by current arriving from corresponding magnetic cell (or cells) via wires connecting to connections 34 and 35 and leads 32 and 33 to, respectively, connections 31c and 31a to, respectively, cathode 28 and anode 29.

In the illustrated embodiment, the anode and cathode electrodes are made of spiral-wound corrugated flat plates of a catalytic material such as iron-nickel metal with oxide coating, to enhance the self-ionization of pure water. The spiral and corrugated configuration is to increase the active area of electrolysis. The catalytic effect is further enhanced by the rotating magnetic fields passing the cells, that also induce eddy currents into the electrode substrates which heat the electrodes, further accelerating the electrolytic reaction.

FIG. 6 shows further details of an interface that a portion of cylindrical separator 27 provides between outside its cylindrical border, where cathode 28 resides, and its inside its cylindrical border, where anode 29 resides. Separator 27 includes holes 601 below spiral cathode 28 and spiral anode 29. This allows water to flow freely between the areas below cathode 28 and anode 29 which helps promote even water levels on either side of the separator.

Separator 27 includes flapped openings 602 above the bottom of cathode 28 and anode 29 but below the water level (which is preferably near the top of cathode 28 and anode 29). The flapped openings allow water and electrical current to flow between the cathode and anode sides of the wall and, at the same time, the upwardly slanted flaps (which are shown as straight lines, but that could be curved in particular embodiments) help prevent any exchange of gas bubbles between cathode and anode sides of the separator 27. Specifically, they help prevent hydrogen bubbles that form on the cathode side from traveling to the anode side and prevent oxygen bubble forming on the anode side from traveling to the cathode side. In one embodiment, the flapped openings are punched out of the material forming the separator wall. In another embodiment, they are molded.

Above the water level, where bubbles of hydrogen gas (on the cathode side) and oxygen gas (on the anode side) have broken into homogeneous hydrogen gas (on the cathode side) and oxygen gas (on the anode side) that is expected to evolve and expand to freely fill open spaces, separator 27 has no openings and is impermeable to hydrogen and oxygen gas to prevent the hydrogen and oxygen gas from mixing.

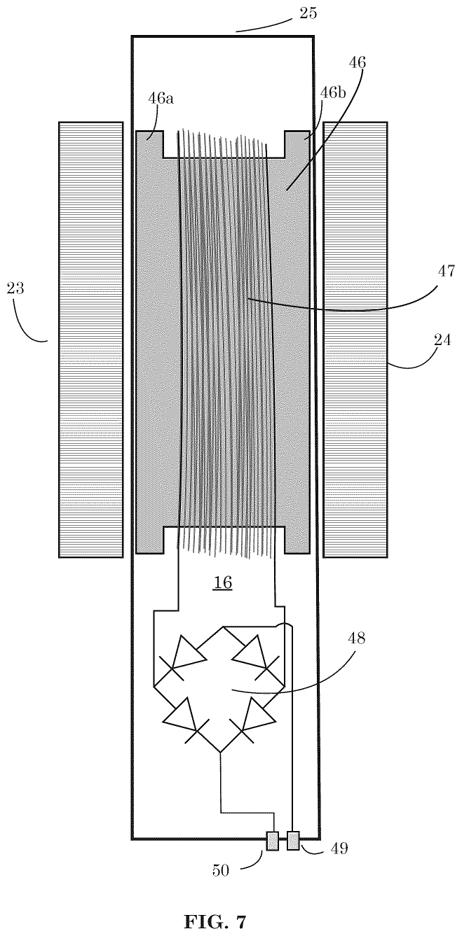

As shown in FIG. 7, each magnetic cell 16 comprises a magnetic core 46 (which can be made out of laminated magnetic steel) with outer pole portion 46a and inner pole portion 46b as well as a winding 47. As further shown in FIG. 7, magnetic cell 16 also includes a full-wave bridge 48.

The purpose of magnetic core 46 is to concentrate the moving magnetic flux between the rotating magnet ring segments 23 and 24 through the winding 47, which is a multiturn coil of insulated copper magnet wire wound around the magnetic steel core 46.

The wire ends of the winding 47 are connected to the ac terminals of full-wave bridge 48. A voltage regulator (not separately shown) is also connected with the bridge. The negative and positive dc terminals of the bridge are connected to output connectors 49 and 50 respectively which, in turn, are connected via internal connections 22 to connectors 34 and 35 (in an electrolytic cell 15) for connection to, respectively, a cathode 28 and an anode 29.

After assembly, the cell casings 25 are filled with a liquid composite filler 45 which, when set, conducts heat away from the cell components, to be dissipated through the cell walls.

If the outer and inner magnet ring segments 23 and 24 are configured with alternating magnet polarities, the full-wave bridge provides the rectified de current required for operation of the electrolytic cells. If the inner and outer magnet ring segments are configured with identically polarized magnets, the bridges serve to convert reverse polarity spikes generated by passage of the magnets leaving the magnetic cell poles into useful dc current.

In the particular embodiment illustrated, the alternating radial arrangement of magnetic cells and electrolytic cells is such that when a pair of magnets is traversing a magnetic cell, a corresponding electrolytic cell is traversing the opposite pair of magnets. The alternating current generated in the magnetic cells is delivered either as pulsating or steady de current (according to the magnet arrangement and polarities) to the electrolytic cells through rectifier bridges 48 (and internal interconnections 22) in the correct polarity required to electrolyse the water, and thus hydrogen gas and oxygen gas evolve from the electrodes.

It should be noted that plain feedwater (river, lake or well water) always has some mineral content but is normally a poor conductor of electricity. In some embodiments of the invention, conduction through the plain feedwater is enhanced by (a) overpotential controlled by switching voltage regulator microcircuits in magnetic cells and (b) added alkalinity in the electrolytic cells.

It should be noted that many aspects of the above embodiments enhance efficiency. For example, using spiral electrodes provides up to 20 times more surface area for a given cell than typical electrodes, thus enhancing hydrogen production. Also, inertial forces in a rotating cell assembly improves gas extraction as does agitation. As another example, pulsating electrical energy applied to the cells enhances ion mobility. As another example, powerful transverse magnetic fields passing through the electrolytic cells enhance efficiency. In general, the internal generation of electric power in various embodiments minimized transmission and transformation losses. In various embodiments, one or more of the following can be implemented to enhance performance: (1) adding perforations in the electrodes to allow internal electrolyte flow and mixing; (2) coating both sides of the spiral electrodes with catalytic material; (3) an enduring alkaline additive within the electrolytic cell can improve conductivity. Other variations and enhancements will be understood by one skilled in the art as being taught by the present disclosure.

It should be noted that, in the illustrated embodiment, electrolytic cells 15 and magnetic cells 16 are preferably modular and readily removeable for maintenance, repair, and/or replacement.

It should also be noted that the drawings are not necessarily to scale. The principles of the illustrated embodiments can be implemented as structures of various scales, depending on the application. In one exemplary application, an apparatus consistent with embodiments disclosed herein is mechanically coupled to a wind turbine to provide rotational energy for driving rotation of the shaft of the hydrogen-generating apparatus.

The invention described in this specification may be embodied in many different forms and should not be construed as limited to the embodiments set forth herein. Rather, these embodiments are provided so that this specification is thorough and complete, and fully conveys the scope of the invention to those skilled in the art. Among other things, this specification may be embodied as methods or devices. While the present invention has been particularly described with respect to the illustrated embodiments, it will be appreciated that various alterations, modifications, and adaptations may be made based on the present disclosure and are intended to be within the scope of the present invention. While the invention has been described in connection with what are presently considered to be the most practical and preferred embodiments, it is to be understood that the present invention is not limited to the disclosed embodiments but, on the contrary, is intended to cover various modifications and equivalent arrangements included within the scope of the underlying principles of the invention as described by the various embodiments referenced above and below.

1. An apparatus for using rotational energy to generate hydrogen from water, the apparatus comprising:
an assembly of magnets arranged around a shaft;
one or more magnetic cells each comprising a magnetic core and wire winding, the one or more magnetic cells being arranged around the shaft and in close proximity to the assembly of magnets such that a current is generated in response movement of the assembly of magnets and the one or more magnetic cells relative to each other;
one or more electrolytic cells electrically coupled to the one or more magnetic cells such that current generated by the one or more magnetic cells provides current for electrolyzing water in the one or more electrolytic cells; and
one or more enclosures coupled to the one or more electrolytic cells to capture hydrogen extracted from the water;
wherein the shaft, the assembly of magnets, and the one or more magnetic cells are mounted such that rotating the shaft causes at least one of the assembly of magnets and the one or more magnetic cells to move relative to the other and in sufficiently close proximity to each other to induce current in the one or more magnetic cells and further wherein internal electrical connections deliver electrical energy from the one or more magnetic cells to the one or more electrolytic cells.

2. The apparatus of claim 1 wherein the shaft and the assembly of magnets are mechanically coupled to each other such that rotating the shaft causes the assembly of magnets to move relative to the one or more magnetic cells.

3. The apparatus of claim 1 wherein the assembly of magnets comprises an inner magnet ring and an outer magnet ring arranged around the shaft and further wherein the one or more magnetic cells are arranged around the shaft between the inner magnet ring and the outer magnet ring.

4. The apparatus of claim 3 wherein the inner magnet ring comprises a plurality of magnets and wherein the outer magnet ring also comprises a plurality of magnets.

5. The apparatus of claim 1 wherein one or more magnetic cells and the one or more electrolytic cells are arranged in alternating fashion to form a ring around the shaft comprising the one or more magnetic cells and the one or more electrolytic cells.

6. The apparatus of claim 1 wherein magnets of the assembly of magnets have a shape profile configured to minimize or eliminate magnetic cogging.

7. The apparatus of claim 6 wherein the shape profile is a parallelogram.

8. The apparatus of claim 1 wherein an electrolytic cell of the one or more electrolytic cells comprises an anode and a cathode, each of the anode and the cathode comprising a catalytic material that enhances disassociation of hydrogen and oxygen in the water.

9. The apparatus of claim 1 wherein the one or more electrolytic cells are mounted such that rotating the shaft causes the assembly of magnets to move relative to the one or more electrolytic cells while in sufficiently close proximity to each other such that the moving magnetic field of the assembly of magnets enhances disassociation of hydrogen and oxygen of in the water.

10. The apparatus of claim 8 wherein the one or more electrolytic cells are mounted such that rotating the shaft causes the assembly of magnets to move relative to the one or more electrolytic cells while in sufficiently close proximity to each other such that the moving magnetic field of the assembly of magnets induces eddy currents in the catalytic material, thereby causing heating that enhances the catalytic action of the catalytic material in enhancing disassociation of hydrogen and oxygen in the water.

11. The apparatus of claim 1 wherein the assembly of magnets is a single magnet ring arranged around the shaft and formed as a single continuous piece of magnetic material.

12. The apparatus of claim 1 wherein the assembly of magnets is a single magnet ring comprising a plurality of magnets arranged around the shaft.
